(19) United States
(12) Patent Application Publication
(10) Pub. No.: US 2024/0305194 A1
(43) Pub. Date: Sep. 12, 2024

(54) VOLTAGE CONVERTER WITH WIDE OUTPUT RANGE

(71) Applicant: Advanced Energy Industries, Inc., Denver, CO (US)

(72) Inventor: Oisin Bernard Anderson, Cork (IE)

(21) Appl. No.: 18/180,883

(22) Filed: Mar. 9, 2023

(51) Int. Cl. H02M 3/157; H02M 1/00

(52) U.S. Cl. CPC H02M 3/157; H02M 1/0009; H02M 1/0025

(57) ABSTRACT

A voltage converter comprises a drive control circuit configured to generate a pair of hysteretic current reference waveforms, generate a comparison signal based on a comparison of an inductor current with a first current reference waveform, and generate an interrupt signal. The drive control circuit is further configured to generate first and second sets of PWM signals configured to control the plurality of controllable switch devices based on one the comparison signal or the interrupt signal, and control the plurality of controllable switch devices based on the first set of PWM signals to generate the inductor current.

### TECHNICAL FIELD

Aspects of the disclosure relate to DC-DC converters and more particularly to multi-level converters that have high efficiency and power density.

### BACKGROUND

A power supply typically converts an incoming input voltage into a different, output voltage. For example, an alternating current (AC) input voltage may be converted to a direct current (DC) voltage for use by electronic equipment. In another example, a first DC input voltage may be converted to a different DC voltage for use by electronic equipment.

Advances in consumer electronics, medical devices and industrial products have demanded increased power density in power conversion circuitry while also reducing losses. This has led to a significant increase in research into alternative converter topologies that can deliver these demands. Flying capacitor multi-level (FCML) converters promise improved efficiency compared to their equivalent two-level topologies by utilizing flying capacitors and additional switches to reduce the voltage across the components, leading to a reduction in losses and the capability to use components rated for lower voltages. This allows for significant reduction in losses, at the expense of more switches and capacitors.

Control challenges associated with the flying-capacitor-based multi-level topologies include implementing a current mode control that allows operation over a wide range of duty-cycles. For example, due to control and operational challenges at particular output voltages (e.g., such as at 0%, 50%, and 100% duty cycles), the use of FCML converters in technologies that may benefit from wide range operation (e.g., capacitor/battery charging applications) may result in suboptimal implementations such as operations within only a narrow range of duty-cycles, utilization of voltage mode controllers, or modification of the switching cycle to avoid operation around certain duty cycles.

### SUMMARY

In accordance with one aspect of the present disclosure, a voltage converter comprises a voltage input adapted to receive an input DC voltage, a DC-to-DC converter comprising a plurality of controllable switch devices and an inductor and configured to convert the input DC voltage into an output DC voltage, a voltage output adapted to receive the output DC voltage, and a drive control circuit. The drive control circuit is configured to generate a pair of hysteretic current reference waveforms, generate a comparison signal based on a comparison of an inductor current through the inductor with a first current reference waveform of the pair of hysteretic current reference waveforms, and generate an interrupt signal in response to an expiration of a watchdog time period occurring before an indication by the comparison signal that one of a peak and a valley the inductor current has been detected. The drive control circuit is further configured to generate a first set of PWM signals configured to control the plurality of controllable switch devices based on one of the comparison signal and the interrupt signal, generate a second set of PWM signals configured to control the plurality of controllable switch devices based on the one of the comparison signal and the interrupt signal, wherein the first and second sets of PWM signals are generated simultaneously, and control the plurality of controllable switch devices based on the first set of PWM signals to generate the inductor current.

In accordance with another aspect of the present disclosure, a method for controlling a voltage converter is presented. The voltage converter comprises a DC-to-DC converter and a drive control circuit. The method comprises generating a pair of hysteretic current reference waveforms, generating a comparison signal based on a comparison of an inductor current with a first current reference waveform of the pair of hysteretic current reference waveforms, and detecting one of a peak and a valley of the inductor current based on the comparison in response to a crossing of the inductor current and the first current reference waveform. The method also comprises generating an interrupt signal in response to an expiration of a watchdog time period; generating a first set of PWM signals based on one of a detected peak, a detected valley, and the interrupt signal, generating a second set of PWM signals based on the one of the detected peak, the detected valley, and the interrupt signal, wherein the first and second sets of PWM signals are generated simultaneously, and controlling the DC-to-DC converter based on the first set of PWM signals to generate the inductor current.

### BRIEF DESCRIPTION OF THE DRAWINGS

The drawings illustrate embodiments presently contemplated for carrying out the invention.

FIG. 1 is a circuit diagram of a multi-level DC-DC step-down converter.

FIG. 2 illustrates a waveform plot showing a current mode control operating below the 50% duty cycle according to an example.

FIG. 3 illustrates a waveform plot showing a current mode control operating above the 50% duty cycle according to an example.

FIG. 4 illustrates a block diagram showing hysteretic current mode control of the multi-level converter of FIG. 1 according to an embodiment.

FIG. 5 illustrates a flowchart of a hysteretic current control mode according to an embodiment.

FIG. 6 illustrates a waveform plot showing a current mode control operating below the 50% duty cycle with hysteretic current slope control according to an example.

FIG. 7 illustrates a waveform plot showing a current mode control operating above the 50% duty cycle with hysteretic current slope control according to an example.

FIG. 8 illustrates a waveform plot illustrating an examplary simulation of the generation of the inductor current according to an example.

FIG. 9 illustrates a waveform plot illustrating an examplary simulation of the generation of the inductor current according to an example.

FIG. 10 illustrates a waveform plot illustrating an examplary simulation of the generation of the inductor current according to an example.

FIG. 11 illustrates a hardware implementation of a portion of the controller of FIG. 4 according to an example.

FIG. 12 illustrates phase controls for controlling the switches of the FCML assembly during the below 50% current control mode according to an example.

FIG. 13 illustrates phase controls for controlling the switches of the FCML assembly during the below 50% current control mode according to an example.

FIG. 14 illustrates a switching phase alignment scheme according to an example.

FIG. 15 illustrates a switching phase alignment scheme according to an example.

FIG. 16 illustrates a switching phase alignment scheme according to an example.

FIG. 17 illustrates a waveform plot illustrating an example of watchdog timer interruption according to an example.

FIG. 18 illustrates adjustment of the charge of the flying capacitor according to an example.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

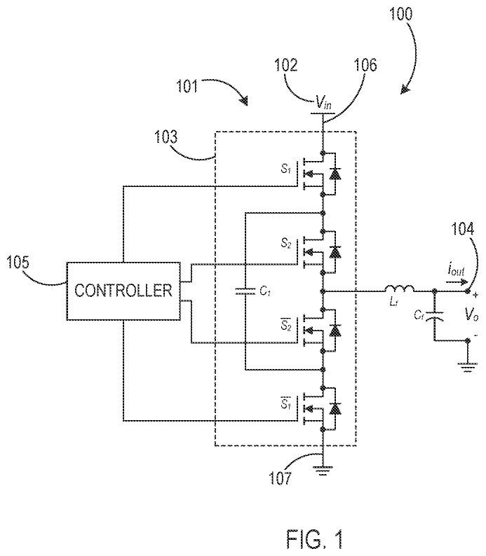

FIG. 1 is a circuit diagram of a multi-level DC-DC step-down converter 100 according to an embodiment. Multi-level converter 100 includes a buck converter circuit 101 having a voltage input 102, a flying capacitor multi-level (FCML) assembly 103, a series choke or inductor L_{f}, an output capacitor C_{f}, a voltage output 104, and a drive control circuit (e.g., controller) 105. The buck converter 101 is a DC-to-DC voltage converter configured to convert an input DC voltage vᵢₙ to a lower output DC voltage vₒ. The FCML assembly 103 includes a multi-stage assembly having a plurality of controllable switch device pairs (e.g., S₁S̅₁, S₂S̅₂, . . . , SnS̅n) and a plurality of flying capacitors (e.g., C₁-Cₙ). Each stage has a controllable switch device pair, and a flying capacitor is coupled between each stage. As illustrated, the FCML assembly 103 is a three-level assembly having two controllable switch pairs with one flying capacitor coupled between the switch pair. Embodiments of the disclosure are not limited to a three-level FCML assembly as shown, however, but can be applied to an FCML assembly of more than three levels. The upper switches (e.g., S̅₁, S̅₂) of the controllable switch device pairs are serially coupled together between a positive terminal 106 of the voltage input 102 and the series inductor L_{f}, and the lower switches (e.g., S̅₁, S̅₂) of the controllable switch device pairs are serially coupled together between a negative terminal 107 of the voltage input 102 and the series inductor L_{f}. The flying capacitors C₁ is coupled between the series-connected pair of upper switches and the series-connected pair of lower switches. For example, the flying capacitor C₁ is coupled between series-connected upper switches S₁, S₂ and series-connected lower switches S̅₁, S̅₂.

The controller 105 is configured to generate control signals e.g., u₁, ū₁, u₂, ū₂ that control the plurality of controllable switch devices S₁, S̅₁, S₂, S̅₂ to produce a desired output voltage at the voltage output 104. In one embodiment, the upper and lower switches of each controllable switch device pair (e.g., S₁,S̅₁) are controlled in a complementary manner such that when one switch (e.g., S₁) is controlled into its conducting state, the other switch (e.g., S̅₁) is controlled into its non-conducting state and vice versa.

Through pulse-width modulation (PWM) such as phase-shifted PWM control signals, the controller 105 uses periodic switching of the controllable switch devices S₁, S̅₁, S₂, S̅₂ to step down the input voltage vᵢₙ. By timing the switches of the multiple stages, pulsating waveforms are produced and filtered by L_{f} so that a conversion from vᵢₙ to vₒ is achieved. The duty cycle of the PWM signals operates to drive the output voltage vₒ to its desired value.

Current mode control offers a simplified frequency response characteristic in the control-to-output transfer function and provides cycle-by-cycle current limiting, which is desirable in many applications that benefit from reliable operation. Control of the multi-level converter 100 over a wide range of duty cycles is presented herein based on a current mode control.

FCML converters have multiple switching states with the order of switching based on the operating mode. For the three-level converter there are four possible switch states which determine the voltage at the switch-node: 0V, 0.5 vᵢₙ (C_{fly} charging), 0.5 vᵢₙ (C_{fly} discharging), and vᵢₙ. Based on the operating mode, the node between the switches S₂, S₂ will alternate between 0V and 0.5 vᵢₙ when the duty cycle is below 50% and will alternate between 0.5 vᵢₙ and vᵢₙ when the duty cycle is above 50%.

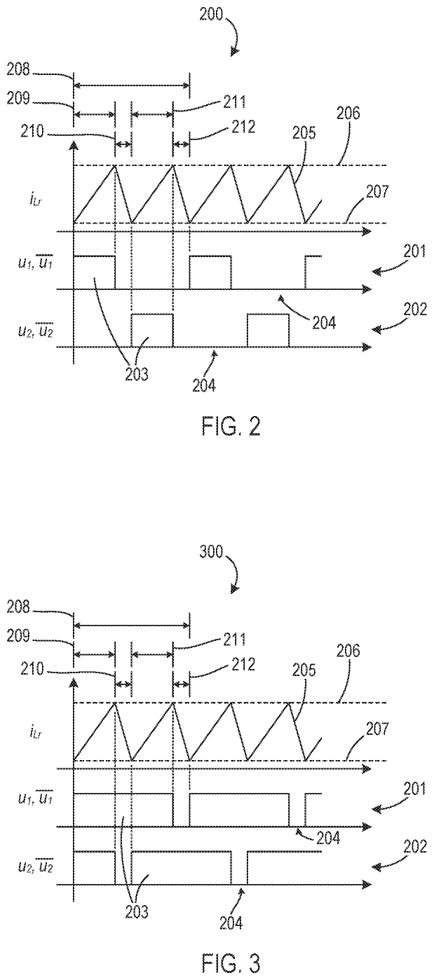

FIG. 2 illustrates a waveform plot 200 showing a current mode control operating below the 50% duty cycle according to an example. A pair of PWM signals 201, 202 for controlling respective switch pairs S₁, S̅₁ and S₂, S̅₂ includes pulses 203 as well as spaces 204 between respective pulses 203 for controlling the switches. The duty cycle of the PWM signals 201, 202 may be determined by a ratio of the on time of a pulse 203 to a total time of the pulse 203 and the following space 204. Current flow 205 through the series inductor L_{f} is controlled by the PWM signals 201, 202 as the flow 205 rises and falls between hysteresis limits 206, 207.

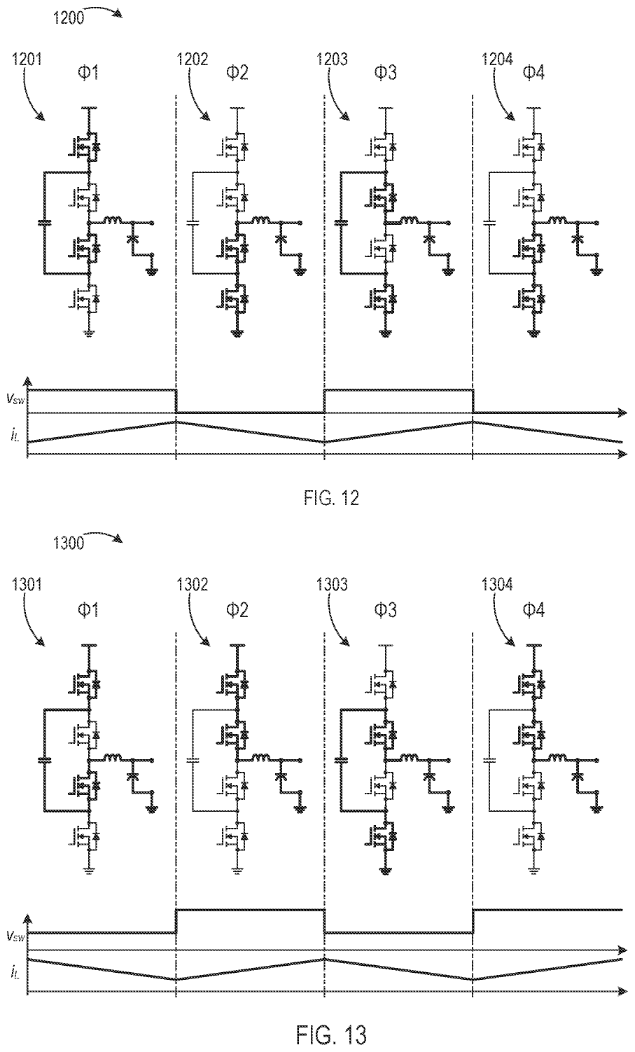

As described herein (e.g., FIGS. 12, 13), control of the switches S₁, S̅₁, S₂, S̅₂ to charge and discharge the flying capacitor C_{fly} includes four phases in the three-level FCML converter control. A complete phase cycle 208 spans two current rise and fall periods. In the first rise-fall period, first and second phases 209, 210 control a first half of the phase cycle 208, and third and fourth phases 211, 212 control a second half of the phase cycle 208. The rise periods 209, 211 represent distinct switching commands for switches S₁, S₂ while the fall periods 210, 212 represent the same switching commands for switches S₁, S₂.

FIG. 3 illustrates a waveform plot 300 showing a current mode control operating above the 50% duty cycle according to an example. The rise periods 209, 211 represent the same switching commands for switches S₁, S₂ while the fall periods 210, 212 represent distinct switching commands for switches S₁, S₂.

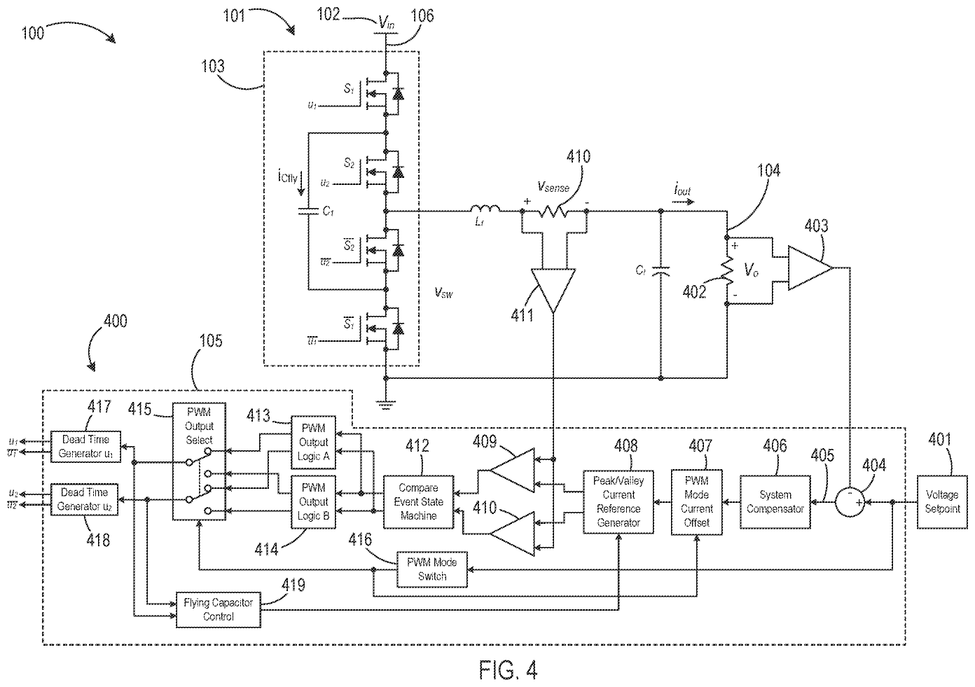

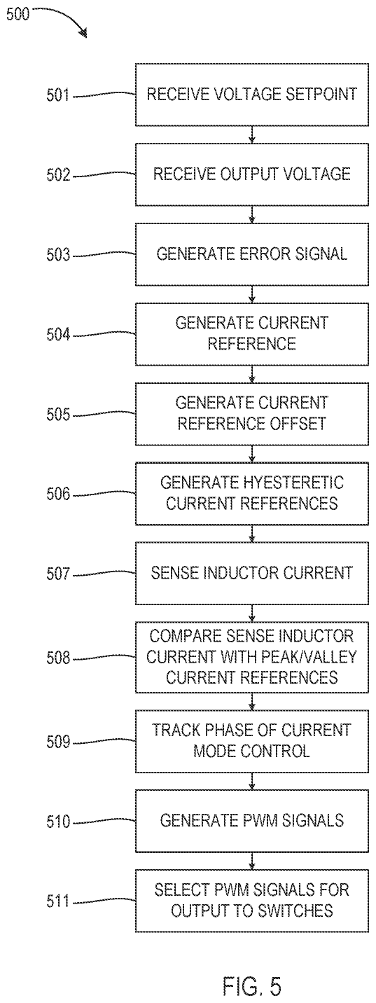

FIG. 4 illustrates the multi-level converter 100 including a block diagram of the controller 105 showing a drive control circuit 400 configured to implement a closed loop hysteretic current mode control of the multi-level converter 100 according to an embodiment. FIG. 5 illustrates a flowchart of the hysteretic current mode control process 500 of the controller 105 according to an embodiment.

Referring to FIGS. 4 and 5, the controller 105 receives a desired output voltage setpoint 401 (step 501) such as from a user, from a system, or from the load 402. A voltage sensor 403 coupled across the voltage output 104 senses the output voltage and provides (step 502) it to the controller 105 for comparing 404 with the voltage setpoint 401 to generate an error signal 405 (step 503). A system compensator 406 receives the error signal 405 and generates a current reference (step 504) indicative of the desired current through the inductor L_{f}. A PWM mode current offset 407 generates an offset (step 505) if needed of the current reference useful for reducing a large inductor current jump in response to switching between the control modes for the type of FCML converter such as between the below 50% mode and the above 50% mode and vice versa for the three-level FCML converter illustrated in the figures as described with respect to FIG. 10.

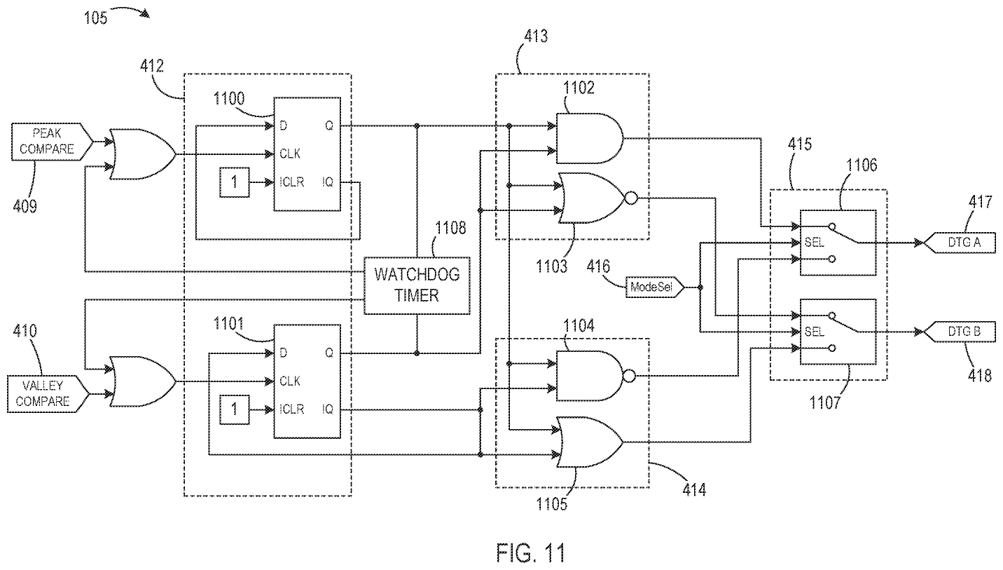

The current reference, including whether it is offset by PWM mode current offset 407, is provided to a current reference generator 408 that generates (step 506) both peak and valley hysteretic current references (including the slopes of the references) for comparison with the current flowing through the inductor L_{f}. The peak hysteretic current reference is provided to a peak comparator 409, and the valley hysteretic current reference is provided to a valley comparator 410. The inductor current is sensed (step 507) via a voltage across a sense resistor 411 in series with the inductor L_{f} that is provided to the peak and valley comparators 409, 410. The sensed inductor current is compared (step 508) with the peak hysteretic current reference to determine whether the inductor current matches or exceeds the peak hysteretic current reference. Similarly, the sensed inductor current is compared (step 508) with the valley hysteretic current reference to determine whether the inductor current matches or exceeds the valley hysteretic current reference. The comparisons are provided to a compare event state machine 412 configured to track (step 509) and set the phase of current mode control (see, e.g., FIGS. 11-13).

The compare event state machine 412 simultaneously provides signals to a pair of PWM output logic generators 413, 414 configured to generate (step 510) the PWM signals (e.g., PWM signals 201, 202) for controlling the switches S₁, S̅₁, S₂, S̅₂. Each PWM output logic generator 413, 414 generates its own respective PWM signals 201, 202. One generator (e.g., PWM output logic generator 413) is responsible for generating the PWM signals 201, 202 that would control the switches S₁, S̅₁, S₂, S̅₂ during above 50% duty cycle control, while the other generator (e.g., PWM output logic generator 414) is responsible for generating the PWM signals 201, 202 that would control the switches S₁, S̅₁, S₂, S̅₂ during the below 50% duty cycle control. Accordingly, the controller 105 simultaneously generates the PWM signals that could be used to control the multi-level converter 100 for output voltages above 50% of the maximum output voltage of the multi-level converter 100 and for output voltages below 50% of the maximum output voltage of the multi-level converter 100.

However, while both PWM signals 201, 202 are generated at the same time, only one set is output to the switches S₁, S̅₁, S₂, S̅₂. A PWM output selector 415 is controlled, via a PWM mode switch 416, to select (step 511) which pair of PWM signals 201, 202 to use. The PWM mode switch 416 determines whether the voltage setpoint 401 is below, at, or above 50% of the vᵢₙ. In response to the voltage setpoint 401 being below 50%, the PWM mode switch 416 controls the PWM output selector 415 to choose the appropriate PWM output logic for operating the multi-level converter 100 according to the below 50% duty cycle current mode control. In response to the voltage setpoint 401 being above 50%, the PWM mode switch 416 controls the PWM output selector 415 to choose the appropriate PWM output logic for operating the multi-level converter 100 according to the above 50% duty cycle current mode control. If the voltage setpoint 401 is at 50%, no change in the currently operating duty cycle current mode control needs to be made in some embodiments.

From the PWM output selector 415, the selected PWM signals 201, 202 are provided to respective dead time generators 417, 418 for outputting the signals to controlling the switches S₁, S̅₁, S₂, S̅₂ according to the selected PWM signals 201, 202 as well as ensuring that corresponding pairs of switches are not controlled into simultaneous conduction modes. The selected PWM signals 201, 202 are also provided to a flying capacitor control 419 for adjusting the peak and valley current references as discussed with respect to FIG. 18 to adjust the charge of the flying capacitor.

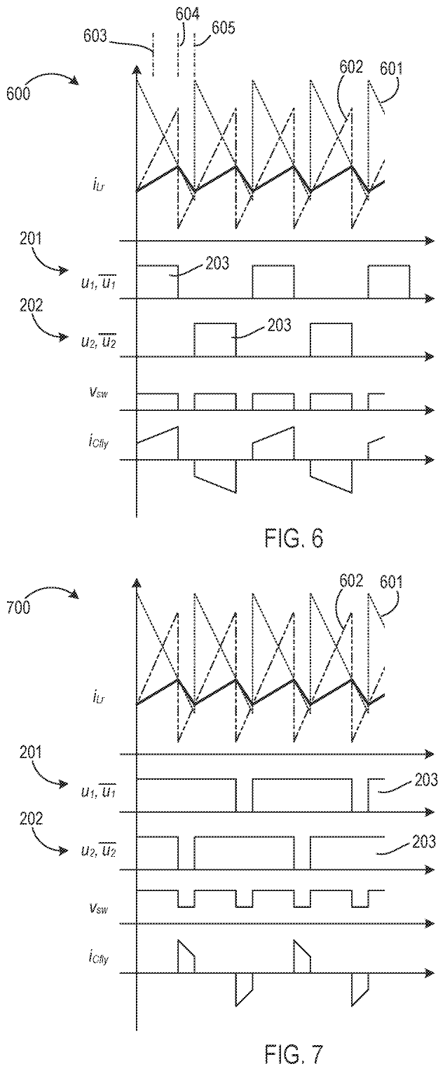

FIG. 6 illustrates a waveform plot 600 showing a current mode control operating below the 50% duty cycle with hysteretic current slope control according to an example. A peak current reference waveform 601 and a valley current reference waveform 602 are generated by the current reference generator 408 as explained above. As time progresses, the value of the peak current reference waveform 601 decreases, creating a negative slope in a direction designed to approach the increasing inductor current i_{Lr} during the charge and discharge phases of the flying capacitor C_{fly}. The value of the valley current reference waveform 602 increases with the passage of time, creating a positive slope in a direction designed to approach the decreasing inductor current i_{Lr} during the phases when the flying capacitor C_{fly} is neither charging nor discharging. In an example, at a first time point 603 positioned within an increasing inductor current phase, the value of the peak current reference waveform 601 is still above the rising inductor current. Accordingly, the comparison of the inductor current to the peak current reference waveform 601 via the peak comparator 409 of FIG. 4 indicates that the current control phase should be maintained. At a second time point 604, the peak of the inductor current has been found by the inductor current matching or exceeding the peak current reference waveform 601. In response, the valley current reference waveform 602 is reset to a value below the inductor current. Though the valley current reference waveform 602 is illustrated as being increased during the increasing inductor current control phase, its value is ignored since the peak of the inductor current is being sought. During the subsequent control phase, the inductor current decreases to meet the increasing valley current reference waveform 602. In response to the valley current reference waveform 602. In response to finding the valley of the inductor current at a third time point 605 as indicated by the valley current reference waveform 602 matching or exceeding the inductor current, the peak current reference waveform 601 is reset to a value above the inductor current, and the next control phase of the inductor current is initiated.

As illustrated in the PWM signal 201, its pulses 203 correspond with every other increasing inductor current phase. As illustrated in the PWM signal 202, its pulses 203 correspond with the increasing inductor current phases not associated with the pulses 203 of the PWM signal 201.

FIG. 7 illustrates a waveform plot 700 showing a current mode control operating above the 50% duty cycle with hysteretic current slope control according to an example. Similar peak and valley current reference waveforms 601, 602 as those illustrated in FIG. 6 are shown in FIG. 7 as being generated by the current reference generator 408. While the control of the waveform plot 600 corresponds with the duty cycle being below 50%, the duty cycle of the waveform plot 700 is above 50%. Accordingly, while the peak and valley current reference waveforms 601, 602 are similar as those illustrated in FIG. 6, the pulses 203 of the PWM signal 201 correspond with three successive increasing-decreasing-increasing inductor current phases. The pulses 203 of the PWM signal 202 similarly correspond with three successive increasing-decreasing-increasing inductor current phases, though they are offset from the pulses 203 of the PWM signal 201.

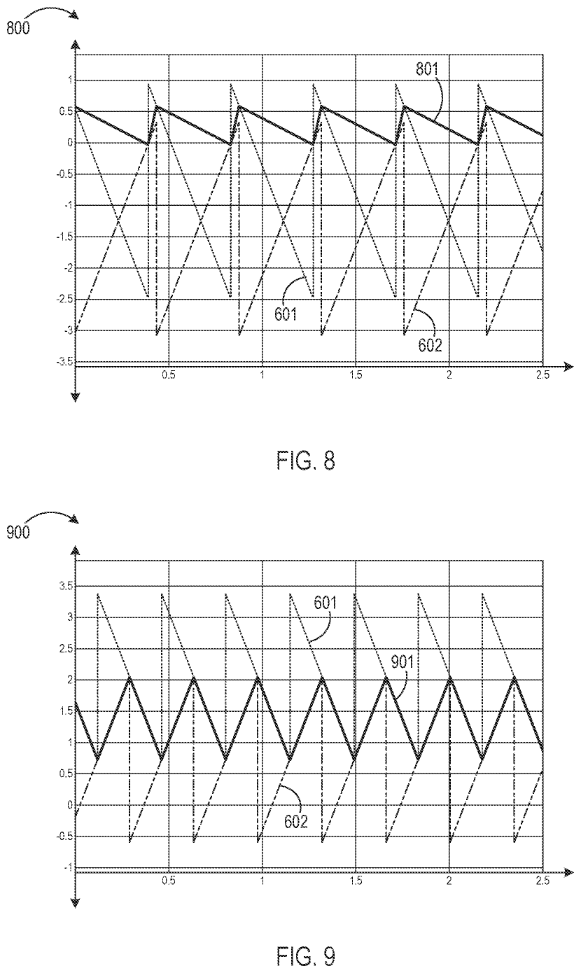

FIG. 8 illustrates a waveform plot 800 illustrating an examplary simulation of the generation of the inductor current 801 in response to a 5% duty cycle current mode control. As shown, the control phases of increasing inductor current are shorter than the control phases of decreasing inductor current. Further, the relationship of the inductor current 801 near the top of the peak and valley current reference waveforms 601, 602 is understood.

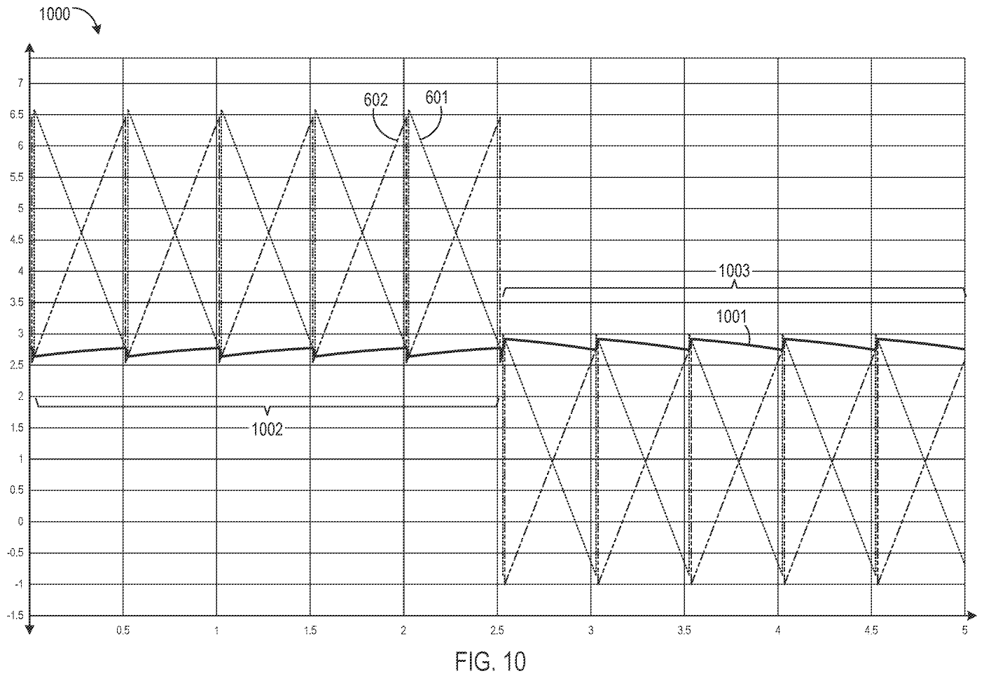

FIG. 9 illustrates a waveform plot 900 illustrating an examplary simulation of the generation of the inductor current 901 in response to a 25% duty cycle current mode control. As shown, the control phases of increasing inductor current are substantially equal to the control phases of decreasing inductor current. Further, the relationship of the inductor current 801 near the center of the peak and valley current reference waveforms 601, 602 is shown.

As illustrated in FIGS. 8 and 9, the frequency of peak and valley detection is different for each of the 5% duty cycle and the 25% duty cycle. As the position of the inductor current changes within the bounds of the peak and valley current reference waveforms 601, 602, the frequency varies. Accordingly, in addition to implementing a current mode control, the controller 105 implements a variable PWM signal frequency influenced by output voltage and current requirements.

FIG. 10 illustrates a waveform plot 1000 illustrating an examplary simulation of the generation of the inductor current 1001 in response to a 49% duty cycle current mode control 1002 transitioning into a 51% duty cycle current mode control 1003. As illustrated in the 49% duty cycle current mode control 1002, the control phases of increasing inductor current are longer than the control phases of decreasing inductor current. Also, the inductor current 1001 is positioned near the bottom of the peak and valley current reference waveforms 601, 602.

In response to a change in the voltage setpoint 401, an output voltage change is resolved in the controller 105 via an output of the PWM mode switch 416 to change the selected PWM signals to output in the PWM output selector 415. In addition, as illustrated, a change from the 49% duty cycle to the 51% duty cycle results in the inductor current 1001 changing its postion with respect to the peak and valley current reference waveforms 601, 602. Where the inductor current 1001 was near the bottom of the peak and valley current reference waveforms 601, 602 during the 49% duty cycle control, its position changes to near the top of the peak and valley current reference waveforms 601, 602 during the 51% duty cycle control. Consequently, to reduce a large current change where the inductor current 1001 jumps from a value below 3 A (near the bottom of the peak and valley current reference waveforms 601, 602) to a value above 6 A (near the top of the peak and valley current reference waveforms 601, 602 generated during the 49% duty cycle control), the PWM mode current offset 407 (FIG. 4) offsets the peak and valley current reference waveforms 601, 602 to lower their values. In this manner, the top portion of the peak and valley current reference waveforms 601, 602 at which the inductor current 1001 is controlled during the 51% duty cycle control is positioned so that the inductor current 1001 of the 51% duty cycle control is near that of the 49% duty cycle control. It is noted that the waveform plot 1000 illustrates simulated steady-state inductor current generation and that a non-steady-state period during the transition from the 49% duty cycle control to the 51% duty cycle control would be expected.

FIG. 11 illustrates a hardware implementation of a portion of the controller 105 according to an example. The comparison signal from the peak comparator 409 is input into a clock input of a D flip-flop 1100. The inverted output of the D flip-flop 1100 is tied to its data input. Accordingly, in response to a low-to-high transition at the clock input, the state of the D flip-flop 1100 toggles. In this manner, each peak identification in the inductor current found in response to comparing the peak current reference waveform 601 with the inductor current toggles the state of the D flip-flop 1100 between low and high values. Similarly, the comparison signal from the valley comparator 410 is input into the clock input of another D flip-flop 1101, which also toggles between low and high values.

The four phases of the switches S₁, S̅₁, S₂, S̅₂ are tracked in the compare event state machine 412. As discussed, for a three-level multi-converter, four states are used to control it. The four states are tracked in, for example, two D flip-flops (see FIG. 11) of the compare event state machine 412. Table 1 below illustrates an example of a mapping of the flip-flop values to the state or phase (e.g., Φ1, Φ2, Φ3, or Φ4) being currently controlled by the PWM signals 201,202.

TABLE 1

| | High flip-flop | Low flip-flop |
|---|---|---|
| Φ1 | 0 | 0 |
| Φ2 | 0 | 1 |
| Φ3 | 1 | 1 |
| Φ4 | 1 | 0 |

As illustrated in FIGS. 4 and 11, the outputs of the compare event state machine 412 are provided to PWM output logic generators 413, 414. The PWM output logic generator 413 includes an AND gate 1102 configured to output a signal to the PWM output selector 415 and a NOR gate 1103 also configured to output a signal to the PWM output selector 415. The PWM output logic generator 414 includes a NAND gate 1104 and an OR gate 1105 configured to output signals to the PWM output selector 415. The outputs of the PWM output logic generator 413 are output from a pair of select switches 1106, 1107 in response to an input logic signal (e.g., a low signal) from the PWM mode switch 416. Alternatively, the outputs of the PWM output logic generator 414 are output from the select switches 1106, 1107 in response to an opposite input logic signal (e.g., a high signal) from the PWM mode switch 416.

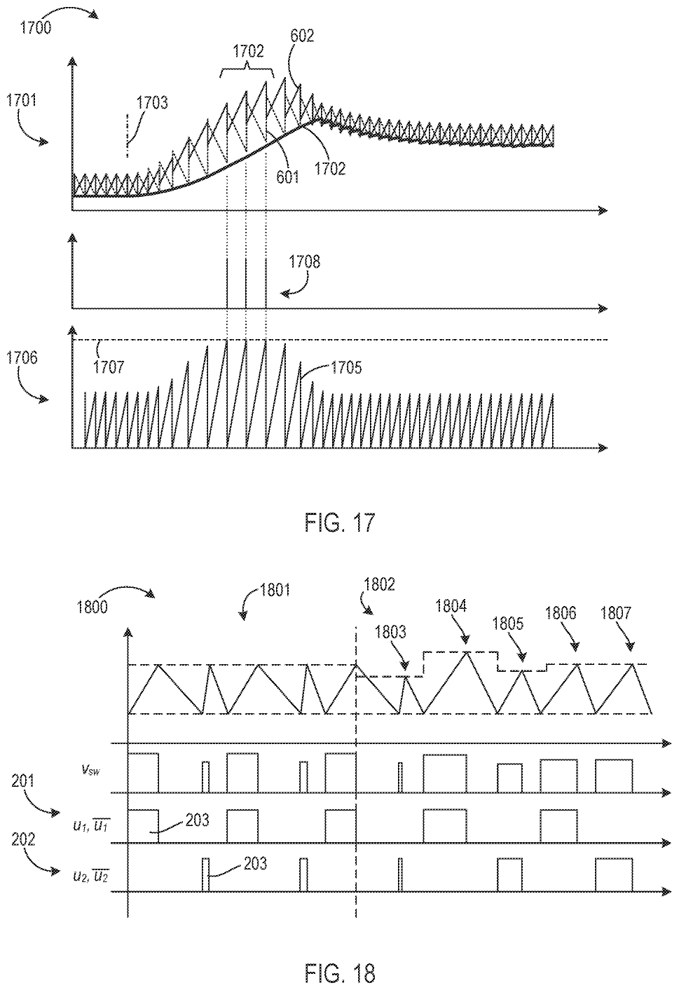

In one embodiment, a watchdog timer 1108 is positioned to receive the outputs Q of the D flip-flops 1100, 1101. Based on the states of the D flip-flops 1100, 1101, the watchdog timer 1108 knows the current state of the compare event state machine 412 and determines which type of peak or valley comparison is expected next. In response to a toggling of the output Q of either D flip-flop 1100 or 1101, the watchdog timer 1108 resets its counter to begin counting while the next peak/valley detection is in progress. In a steady-state condition of the multi-level converter 100, for example, the expiration time of the watchdog timer 1108 is set to a value beyond a time expected for a maximum peak or valley detection. If the expiration time is reached prior to detection of the next peak/valley, the watchdog timer 1108 transmits a corresponding peak or valley detection signal to the CLK input of the respective D flip-flop 1100, 1101 responsible for detecting the expected peak/valley. For example, if a peak is expected to be detected, the watchdog timer 1108 transmits a clock pulse to the CLK input of the D flip-flop 1100. This transmission occurs at the end of the expiration time since no peak has been yet detected within the expiration time. In response, the PWM output logic generators 413, 414 change to generate the next phase of switch control appropriate for generating a decreasing inductor current condition while the next valley detection is expected. A waveform plot illustrating an example of watchdog timer interruption is illustrated in FIG. 17.

While a hardware logic circuit is illustrated in FIG. 11 as generating and providing the PWM signals 201, 202 to the switches S₁, S̅₁, S₂, S̅₂, embodiments of this disclosure also contemplate software/firmware implementations within the controller 105 or via a separate controller to generate the signals 201, 202. For example, a software implementation may rely on state flags as well as interrupts to determine the outputs for the compare event state machine. A high compare flag, HComp, and a low compare flag, LComp, may be used to store the current state for correlation with a related control phase. The output provided by the hardware D flip-flop 1100 in the logic implementation illustrated in FIG. 11 is represented in the software lookup table below as the “A” output, while the output provided by the hardware D flip-flop 1101 is represented in the lookup table below as the “B” output. In response to receiving an interrupt, which is generated in the case of finding a peak in the inductor current, a valley in the inductor current, or an expiration of a watchdog timer, the appropriate HComp or LComp flag may be toggled, and the lookup table (Table 2 below) may be accessed to set the A and B outputs for generation of the corresponding PWM signals 201, 202.

TABLE 2

| Input | Output |
|---|---|
| HComp: 0 | A: 0 |
| LComp: 0 | B: 1 |
| Above50: 0 | |
| HComp: 1 | A: 0 |
| LComp: 0 | B: 0 |
| Above50: 0 | |
| HComp: 1 | A: 1 |
| LComp: 1 | B: 0 |
| Above50: 0 | |
| HComp: 0 | A: 0 |
| LComp: 1 | B: 0 |
| Above50: 0 | |
| HComp: 0 | A: 1 |
| LComp: 0 | B: 1 |
| Above50: 1 | |
| HComp: 1 | A: 0 |
| LComp: 0 | B: 1 |
| Above50: 1 | |
| HComp: 1 | A: 1 |
| LComp: 1 | B: 1 |
| Above50: 1 | |
| HComp: 0 | A: 1 |
| LComp: 1 | B: 0 |
| Above50: 1 | |

As discussed herein, a three-level FCML such as the multi-level converter 100 presented throughout this disclosure, includes four phases in controlling the charge and discharge cycles of the flying capacitor C_{fly}. FIGS. 12 and 13 illustrate exemplary phase controls for controlling the switches of the FCML assembly during the below 50% mode (FIG. 12) and the above 50% mode (FIG. 13) to achieve the desired charge and discharge cycles of the flying capacitor C_{fly}.

FIG. 12 illustrates a below 50% phase sequence 1200. A first phase (Φ1) 1201 activates switches S₁, S̅₂ to begin a first inductor current increasing phase during which the flying capacitor is charging. The voltage at the switch-node is 0.5 vᵢₙ during Φ1 1201. In a next phase (Φ2) 1202 begun in response to detecting a peak in the increasing inductor current, switch S₁ is turned off while switch S̅₁ is turned on to begin a first inductor current discharging phase during which the flying capacitor charge is maintained. The voltage at the switch-node is 0 V during Φ2 1202. A second inductor current increasing phase is activated in a third phase (Φ3) 1203 in response to detecting a valley in the decreasing inductor current and during which the flying capacitor is discharging by turning off the switch S̅₂ and turning on the switch S₂. The voltage at the switch-node is 0.5 vᵢₙ during Φ3 1203. A fourth phase (4) 1204 is subsequently entered into in response to detecting a peak in the increasing inductor current. Φ4 1204 is identical to Φ2 1202. The four phases are repeated in response to detecting a valley in the inductor current during Φ4 1204.

FIG. 13 illustrates an above 50% phase sequence 1300. A first phase (Φ1) 1301 is identical to Φ1 1201 of phase sequence 1200. A second phase (Φ2) 1302 is begun in response to detecting a valley in the decreasing inductor current. In contrast to Φ2 1202 of FIG. 12, Φ2 1302 turns on switches S₁, S₂ rather than switches S̅₁, S̅₂. Accordingly, vᵢₙ is provided at the switch-node through switches S₁, S₂ to the inductor to generate an inductor current charging phase. In response to detecting a peak in the increasing inductor current, a third phase (Φ3) 1303 is initiated similarly to the Φ3 1203 of FIG. 12. A valley detection in the decreasing inductor current of Φ3 1303 causes a fourth phase (Φ4) 1304 to be entered into. Φ4 1304 is identical to Φ2 1202.

As described herein, the controller 105 is configured to generate simultaneous PWM signals 201, 202 for both the below 50% current mode control and the above 50% current mode control. Accordingly, a PWM signal 201 and a PWM signal 202 for the below 50% current mode control and separate PWM signals 201, 202 for the above 50% current mode control are simultaneously generated by the controller 105. While both sets of separate PWM signals 201, 202 are generated, only the relevant signals for the above or below 50% current mode control as controlled by the voltage setpoint 401 and the PWM mode switch 416 are forwarded on to the switches S₁, S̅₁, S₂, S̅₂ via the PWM output selector 415.

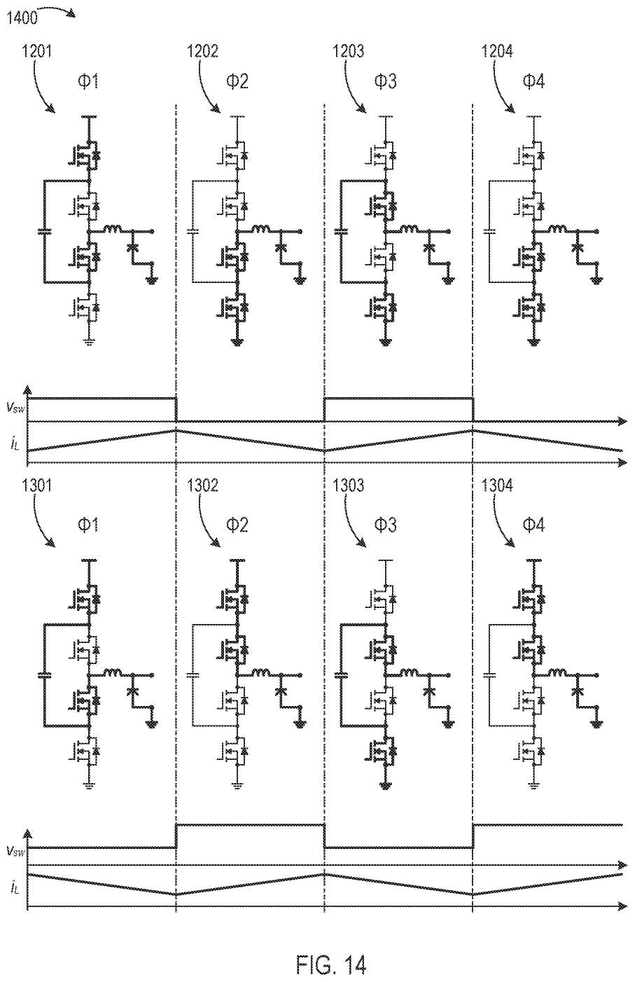

Based on the phase sequences 1200, 1300 illustrated in FIGS. 12 and 13, at least three alignment schemes of the phase sequences 1200, 1300 are possible in generating the simultaneous PWM signals 201, 202. FIG. 14 illustrates a switching phase alignment scheme according to an example in which the phase sequences 1200, 1300 are positioned in a phase-aligned switching order 1400. As illustrated, PWM signals for the Φ1 (1201, 1301) are generated at the same time as the beginning phases to be used in the phase sequences. Similarly, Φ2 (1202, 1302), Φ3 (1203, 1303), and Φ4 (1204, 1304) are also respectfully simultaneously generated. In this manner, Φ1-Φ4 (1201-1204) of the phase sequence 1200 directly overlap the Φ1-Φ4 (1301-1304) of the phase sequence 1300.

As illustrated in FIG. 14, the capacitor charging and discharging states occur at the same time (Φ1 and Φ3). Accordingly, transitioning between above/below 50% modes during Φ1 or Φ3 will have an identical capacitor charge/discharge cycle. However, the slopes of the inductor current (and, therefore, the next expected peak/valley event) are different between the modes of operation, even if the capacitor states (e.g., Φ1 and Φ3) are aligned. When operating below 50% duty cycle is used and the flying capacitor is connected to the inductor, the inductor current will rise. Conversely, when operating above 50% duty cycle and the flying capacitor is connected to the inductor, the current will decrease. Similarly, the operation of the inductor current is opposite in Φ2 and Φ4. Without accounting for this, the converter will stall whenever the mode of operation is switched to the opposite above/below 50% current control mode, as the next expected peak or valley will not occur in the subsequent opposite phase since the current does not change direction. For example, if, in response to detecting a peak at the end of Φ1 1201, Φ2 1302 is initiated due to a change to the above 50% current mode control, since the inductor current is again rising, no valley can be detected. In one embodiment, accounting for the disparity in increasing/decreasing inductor current between the phase sequences 1200, 1300 when switching between above/below 50% current mode controls, the next phase may be skipped in favor of implementing the following phase. For example, switching between the above/below 50% current mode controls may include initiating respective Φ3 (1203, 1303) immediately after respective Φ1 (1301, 1201) or vice-versa. Similarly, respective Φ2 (1202, 1302) and respective Φ4 (1304, 1204) may be adjacently controlled when switching between the above/below 50% current mode controls.

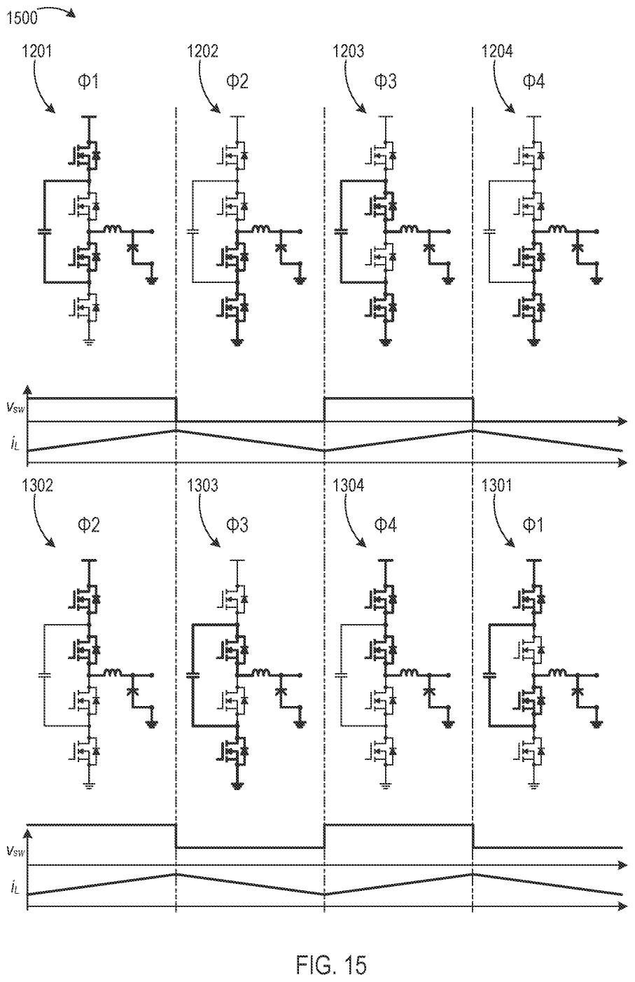

FIG. 15 illustrates a switching phase alignment scheme 1500 according to an example in which the phase sequences 1200, 1300 are positioned in a current-aligned switching order in which the inductor current is matching in its increasing/decreasing state while the phases 1301-1304 are “advanced” in relation to the phases 1201-1204. As shown, Φ1 1201 aligns with Φ2 1302. In these phases, the inductor current is increasing. Similarly, Φ2-Φ4 (1202-1204) are aligned with respective Φ3-Φ1 (1303-1301). In this scheme 1500, switching between respective Φ1-Φ4 (1201-1204) to respective Φ3-Φ2 (1303-1302) results in an expected next conduction mode of the inductor. For example, switching from Φ1 1201 to Φ3 1303 results in an increasing inductor current mode followed by a decreasing inductor current mode. In this manner, after a peak detection during Φ1 1201, a next valley detection during Φ3 1303 naturally follows.

Switching from respective 3-Φ2 (1303-1302) of the above 50% current mode control to respective Φ1-Φ4 (1201-1204) of the below 50% current mode control, however, may generate an undesirable condition where back-to-back switching states occur. For example, switching from Φ3 1303 to Φ3 1203 results in a dual flying capacitor discharging period. Switching from Φ1 1301 to Φ1 1201 results in a dual flying capacitor charging period. These extended charging or discharging periods may cause an adverse effect to the inductor current during a switching period due to deviation of the flying capacitor voltage or otherwise adversely affect operation of the multi-level converter 100. To minimize such adverse effects, switching from the above 50% current mode control to the below 50% current mode control may be restricted to occurring after a peak has been detected such as in Φ2 1302 or Φ4 1304. Alternatively, if switching after a valley detection is desired, two phases of the below 50% current mode control may be skipped when switching thereto.

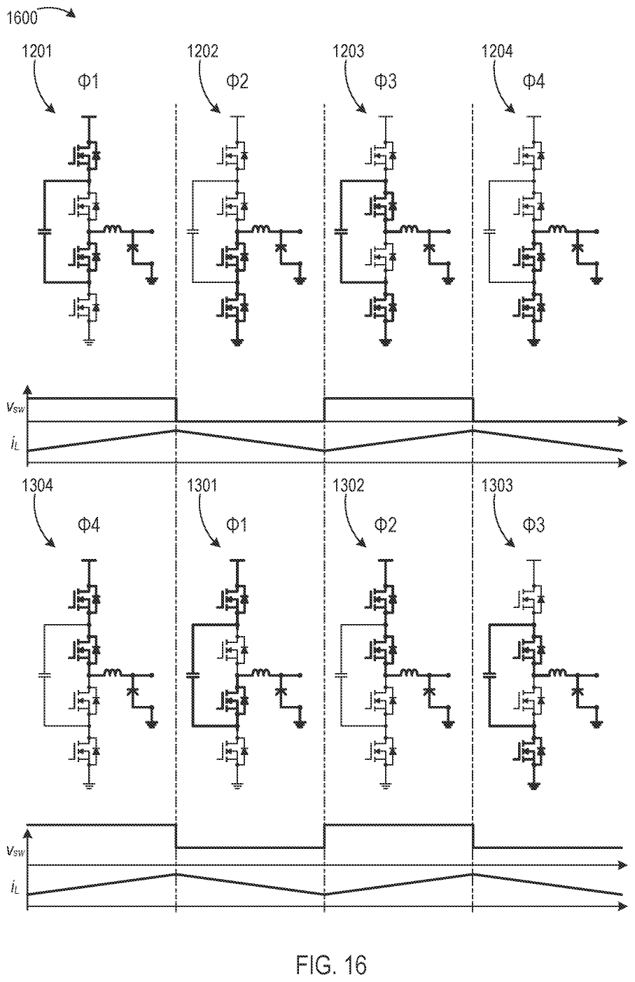

FIG. 16 illustrates a switching phase alignment scheme 1600 according to an example in which the phase sequences 1200, 1300 are positioned in a current-aligned switching order in which the inductor current is matching in its increasing/decreasing state while the phases 1301-1304 are “delayed” in relation to the phases 1201-1204. As shown, Φ1 1201 aligns with Φ4 1304. In these phases, the inductor current is increasing. Similarly, Φ2-Φ4 (1202-1204) are aligned with respective Φ1-Φ3 (1301-1303). In this scheme 1600, switching between respective Φ1-Φ4 (1201-1204) to respective Φ1-Φ4 (1301-1304) results in an expected next conduction mode of the inductor. For example, switching from Φ1 1201 to Φ1 1301 results in an increasing inductor current mode followed by a decreasing inductor current mode. In this manner, after a peak detection during Φ1 1201, a next valley detection during Φ3 1303 naturally follows. However, similarly to the switching from respective Φ3 1303 to Φ3 1203 or Φ1 1301 to Φ1 1201 of the alignment scheme 1500 of FIG. 15, switching from Φ1 1201 to Φ1 1301 or from Φ3 1203 to Φ3 1303 in FIG. 16 results in a dual flying capacitor charging/discharging period. To minimize such adverse effects, switching from the below 50% current mode control to the above 50% current mode control may be restricted to occurring after a valley has been detected such as in Φ2 1202 or Φ4 1204. Alternatively, if switching after a peak detection is desired, two phases of the below 50% current mode control may be skipped when switching thereto. Switching between Φ4-Φ1 (1304-1301) of the above 50% current mode control to subsequent Φ2-Φ1 (1202-1201), however, may occur after detection of either a peak or a valley in the inductor current.

FIG. 17 illustrates an example of watchdog timer interruption 1700 according to an example. In a first waveform plot 1701, hysteretic current control of the multi-level converter as disclosed herein is generated to produce an inductor current 1702. At the beginning of the waveform plot 1701, the peak current reference waveform 601 and valley current reference waveform 602 are generated to produce the inductor current 1702 at a first, lower current value. At about a first time point 1703, an output current requirement is received to increase the output current to a new, higher value. Accordingly, the controller 105 (FIGS. 1, 4) starts to increase the values of the peak and valley current reference waveform 601, 602 to increase the inductor current 1702. In one embodiment, the increase of the inductor current 1702 may be gradual to avoid a triggering of the watchdog timer 1108. However, a gradual increase may be too slow for conditions, and a faster rise to the new current level may be preferred. As such, the values of the peak and valley current reference waveform 601, 602 are increased sufficiently to shorten the time required to increase the inductor current 1702 to the higher value. As illustrated, the valley current reference waveform 602 is raised to values above the inductor current 1702 such that in response to detecting a peak event through a comparison with the peak current reference waveform 601, a subsequent valley detection occurs at the next valley comparison. In this manner, the inductor current 1702 may continue in an increasing manner without decreasing a significant amount.

The reset values of the peak current reference waveform 601 representing the lowest values of the peak current reference waveform 601 are also aggressively adjusted to allow for a maximum or other optimal increase to the inductor current 1702. As illustrated, during a certain time period 1704, the lowest reset values of the peak current reference waveform 601 are set too high such that the peak comparator 409 fails to detect the intersection of or a crossing of the decreasing peak current reference with the inductor current 1702. A watchdog timer counter 1705 internal to the watchdog timer 1108 (FIG. 11) is illustrated in a second waveform plot 1706. As illustrated, the counter of the watchdog timer gets closer to the watchdog expiration time or time period 1707 as the watchdog timer signal 1705 approaches the time period 1704. In response to the expiration time of the watchdog timer signal 1705 reaching the expiration time during the time period 1704 in response to the peak current reference waveform 601 failing to intersect with or cross the inductor current 1702, a watchdog output interrupt or clock pulse 1708 is output to the peak D flip-flop 1100 as described above with respect to FIG. 11 to cause the compare event state machine 412 to register a peak event. As shown, during the time period 1704, both of the peak and valley current reference waveforms 601, 602 are outside of a range of the inductor current 1702 within the expiration of the watchdog expiration time 1707. Following the time period 1704, the peak current reference waveform 601 begins to intersect with or cross the increased inductor current 1702 prior to expiration of the watchdog expiration time 1707 such that further watchdog clock signals from the watchdog timer 1108 are not needed.

FIG. 18 illustrates a waveform plot 1800 balancing the charge of the flying capacitor according to an example. As shown in a first portion 1801, a width of the pulses 203 of the PWM signal 201 is larger than a width of the pulses 203 of the PWM signal 202, and a voltage at the switch node v_{sw} is irregular as illustrated in FIG. 18. The different widths result from at least a deviation in the voltage of the flying capacitor C_{fly}. FIG. 18 illustrates a control scheme to reset the flying capacitor.

As shown in a second portion 1802, balancing the flying capacitor includes reducing the time at which the next peak occurs 1803. Reducing the peak detection time may include reducing the reset value of the peak current reference waveform 601 to ensure that the peak current reference waveform 601 intersects with or crosses the indutor current sooner. The peak reduction reduces the width of the pulse 203 of the PWM signal 202. In a subsequent peak detection 1804, the reset value of the peak current reference waveform 601 is increased to lengthen the peak detection time, thus increasing the width of the pulse 203 of the PWM signal 201. For the next peak detection 1805, the reset value or starting point of the peak current reference waveform 601 is again lowered but not as far as for the peak detection 1803. The reset value of the peak current reference waveform 601 is again raised for the next peak detection 1806. As the reset value of the peak current reference waveform 601 has returned to the expected value and since the pulses 203 for both the PWM signals 201, 202 are substantially equal for peak detection 1806 and peak detection 1807, the flying capacitor has been successfully balanced.

Embodiments of this disclosure present a hysteretic current mode control scheme for multi-level converters that allows operation over a wide output range of the converter. This wide output voltage operation is achieved by dynamically changing the PWM generation scheme when transitioning above or below the certain duty cycles of the converter.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

1. A voltage converter comprising:
a voltage input adapted to receive an input DC voltage;
a DC-to-DC converter comprising a plurality of controllable switch devices and an inductor and configured to convert the input DC voltage into an output DC voltage;
a voltage output adapted to receive the output DC voltage;
a drive control circuit configured to:
generate a pair of hysteretic current reference waveforms;
generate a comparison signal based on a comparison of an inductor current through the inductor with a first current reference waveform of the pair of hysteretic current reference waveforms;
generate an interrupt signal in response to an expiration of a watchdog time period occurring before an indication by the comparison signal that one of a peak and a valley the inductor current has been detected;
generate a first set of PWM signals configured to control the plurality of controllable switch devices based on one of the comparison signal and the interrupt signal;
generate a second set of PWM signals configured to control the plurality of controllable switch devices based on the one of the comparison signal and the interrupt signal, wherein the first and second sets of PWM signals are generated simultaneously;
control the plurality of controllable switch devices based on the first set of PWM signals to generate the inductor current.

2. The voltage converter of claim 1, wherein the DC-to-DC converter comprises a flying capacitor multi-level (FCML) converter.

3. The voltage converter of claim 2, wherein the FCML converter comprises a three-level FCML converter; and
wherein the plurality of controllable switch devices comprises:
a first pair of controllable switches; and
a second pair of controllable switches.

4. The voltage converter of claim 1, wherein a duty cycle of the first set of PWM signals is below 50%; and
wherein a duty cycle of the second set of PWM signals is above 50%.

5. The voltage converter of claim 1, wherein the drive control circuit is further configured to:
receive a voltage setpoint;
generate the first set of PWM signals to generate the inductor current sufficient to output the output DC voltage via the voltage output.

6. The voltage converter of claim 5, wherein the drive control circuit is further configured to alter, in response to receiving an altered voltage setpoint, the pair of hysteretic current reference waveforms to induce a change in the inductor current sufficient to alter the output DC voltage based on the altered voltage setpoint.

7. The voltage converter of claim 6, wherein the drive control circuit is configured to generate the interrupt signal in response to the pair of hysteretic current reference waveforms being outside of a range of the inductor current within the expiration of the watchdog time period.

8. The voltage converter of claim 4, wherein a duty cycle of the first set of PWM signals is above 50%; and
wherein a duty cycle of the second set of PWM signals is below 50%.

9. The voltage converter of claim 1, wherein the first current reference waveform comprises a descending slope of current reference values; and
wherein the drive control circuit is configured to generate the indication that the peak has been detected in response to a current value of the inductor current exceeding a current value of the descending slope of current reference values.

10. The voltage converter of claim 1, wherein the first current reference waveform comprises an ascending slope of current reference values; and
wherein the drive control circuit is configured to generate the indication that the valley has been detected in response to a current value of the descending slope of current reference values exceeding a current value of the inductor current.

11. A method for controlling a voltage converter, wherein the voltage converter comprises:
a DC-to-DC converter; and
a drive control circuit;
wherein the method comprises:
generating a pair of hysteretic current reference waveforms;
generating a comparison signal based on a comparison of an inductor current with a first current reference waveform of the pair of hysteretic current reference waveforms;
detecting one of a peak and a valley of the inductor current based on the comparison in response to a crossing of the inductor current and the first current reference waveform;
generating an interrupt signal in response to an expiration of a watchdog time period;
generating a first set of PWM signals based on one of a detected peak, a detected valley, and the interrupt signal;
generating a second set of PWM signals based on the one of the detected peak, the detected valley, and the interrupt signal, wherein the first and second sets of PWM signals are generated simultaneously; and
controlling the DC-to-DC converter based on the first set of PWM signals to generate the inductor current.

12. The method of claim 11 further comprising generating the interrupt signal prior to the detection of the one of the peak and the valley.

13. The method of claim 11 further comprising:
receiving a first voltage setpoint;
determining a duty cycle of the first set of PWM signals based on a relationship of the first voltage setpoint to an input voltage supplied to the DC-to-DC converter.

14. The method of claim 13, wherein the duty cycle of the first set of PWM signals is below 50%.

15. The method of claim 14 further comprising:
receiving a second voltage setpoint, wherein the second voltage setpoint is greater than the first voltage setpoint;
determining a duty cycle of the second set of PWM signals based on a relationship of the second voltage setpoint to the input voltage; and
controlling the DC-to-DC converter based on the second set of PWM signals to generate the inductor current.

16. The method of claim 15, wherein the duty cycle of the second set of PWM signals is above 50%.

17. The method of claim 15 further comprising:
generating a current reference offset in response to the relationship of the second voltage setpoint to the input voltage; and
altering the pair of hysteretic current reference waveforms based on the current reference offset.

18. The method of claim 15 further comprising generating the interrupt signal during a change in the inductor current in response to a change in controlling the DC-to-DC converter from being based on the first set of PWM signals to being based on the second set of PWM signals.

19. The method of claim 11, wherein the DC-to-DC converter comprises a three-level flying capacitor multi-level converter comprising a flying capacitor.

20. The method of claim 19 further comprising altering a length of time between a detection of a peak and a detection of a subsequent valley to adjust a deviation in a voltage of the flying capacitor.
